(19) United States
(12) Patent Application Publication
(10) Pub. No.: US 2004/0121106 A1
(43) Pub. Date: Jun. 24, 2004

(54) Portable disposable personal article containing a product for body care

(76) Inventors: Nilo Lemos Cobeiros, Sao Jose dos Campos (BR); Rogerio Costa, West Windsor, NJ (US); Joseph David Melnik, Princeton, NJ (US); Francisco Antonio Rimoli, Mogi das Cruzes (BR); Julio Malva Filho, Sao Jose dos Campos (BR)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/257,048

(22) PCT Filed: Apr. 6, 2001
(86) PCT No.: PCT/BR01/00042

(30) Foreign Application Priority Data
Apr. 7, 2000 (BR) PT0001191-6

(51) Int. Cl. B32B 9/00

(52) U.S. Cl. 428/42.3; 428/500

(57) ABSTRACT

Portable disposable personal article containing a product for body care, comprising a substrate (S) of flexible material, which is water and oil insoluble and consists of a basic film (10) having a front face incorporating, in a single piece, a plurality of projecting tabs (11), which are mutually interconnected, in order to define substantially prismatic and anteriorly opened cavities (12), and a single amount of a product (P) for body care, which is deposited on the front face of the basic film (10), in order to fill at least partially a certain number of cavities, in which it is retained.

### FIELD OF THE INVENTION

The present invention refers to a portable disposable personal article containing a respective predetermined single amount of a product for personal hygiene, protection, or external treatment of the user's body.

### BACKGROUND OF THE INVENTION

Disposable, personal articles of single use are well known in the art, comprising a water insoluble substrate, usually with the shape of a pad, a non-woven cloth tissue or sponge, to which is aggregated a dry or substantially dry product for external use, such as a product for personal hygiene or for skin or hair treatment.

Such prior art articles have their substrate formed so as to retain only dry or substantially dry products and, for this reason, need to be at least partially diluted, usually in water, in order to be released from the substrate and applied to the user's body. Thus, these articles have not been able to provide the potential users with single portable amounts of products for external body care, which are invariably available in a pasty-liquid state, such as it occurs with creamy lotions and even with creams used for skin or hair treatment or protection in different circumstances.

Besides the aforementioned limitation related to the use of products being aggregated to the substrate only in the dry state, these known articles do not present a substrate structure which functions, simultaneously, as a vehicle carrying a single amount of a dry, pasty-liquid or liquid product to be applied to the user, and also as a vehicle for applying and spreading the product and for skin exfoliation, which further aids in the formation of foam in the case of a personal hygiene product containing a surfactant.

The articles of the type considered herein and already known do not have, in their structures, sufficient characteristics necessary for retaining pasty-liquid products, in order to assure that these products are contained within the article without using complex constructions in the form of hermetic bags which, besides requiring a certain effort and auxiliary instruments to be torn, do not have any function related to the application of the product onto the user's body.

In the articles known in the art and which also have an application function, it is not possible to minimize or even stop the migration of the pasty-liquid product along the article and even out of said article. The use of such products in single amounts leads to the known articles in hermetic bags, with the above-mentioned deficiencies.

Another deficient aspect of the known articles relates to the little or no efficiency of the gripping means available for the user to retain the substrate using one hand, while applying the product to the body. The ineffectiveness of the gripping means, defined by the substrate body itself, makes the substrate structure usually function only as a storing/carrying vehicle and not as a vehicle for carrying and applying the product.

### DISCLOSURE OF THE INVENTION

Thus, it is an object of the present invention to provide a portable disposable personal article having a substrate of simple construction and containing an easily accessible single amount of a dry, pasty-liquid or liquid product for body care, including face, hair and nails.

A further object of the present invention is to provide an article as defined above and whose substrate may simultaneously function as a vehicle for carrying and applying the dry, pasty-liquid or liquid product aggregated thereto and contained therein, directly acting on the user's body.

Still another object of the present invention is to provide an article as defined above and which incorporates gripping means to facilitate its use as an application means of the carried product.

These and other objectives of the invention are achieved by providing an article of the type considered herein, comprising a substrate of flexible material, which is water and oil insoluble and which consists of a basic film having a front face incorporating, in a single piece, a plurality of projecting tabs, which are mutually interconnected in order to define, with each other and with the basic film, substantially prismatic cavities having any polygonal base and being anteriorly open, and a single amount of a dry, substantially dry, pasty-liquid, or liquid product for body care, including face, hair or nails, which is deposited on the upper face of the basic film, in order to fill at least partially a certain number of cavities, in which it is retained.

### BRIEF DESCRIPTION OF THE DRAWINGS

The invention will be described below, with reference to the appended drawings, in which:

FIG. 1 is a perspective view of the portable disposable personal article of the present invention, according to an embodiment in which it is commercialized inside an envelope-shaped package made of a usually impermeable and easily torn material;

FIG. 2 is a view similar to that of FIG. 1, but with the envelope in a partially open condition;

FIG. 3 is a view similar to that of FIG. 2, but with a different construction of the initial opening portion of the envelope;

FIG. 4 is a cross-sectional view of the article shown in FIG. 1, taken along line IV-IV in FIG. 1;

FIG. 5 is a cross-sectional view of the flattened substrate, containing an amount of body care product and placed inside an envelope-shaped package similar to that illustrated in FIG. 1;

FIG. 6 is a front plan view of the assembly of FIG. 3, after the envelope and the substrate itself have been completely opened and flattened;

FIG. 7 is a front perspective view of the article of FIG. 5 when mounted to the user's fingers;

FIG. 8 is a front plan view of the assembly of FIGS. 1 and 2, after the envelope and the substrate itself have been completely opened and flattened;

FIG. 9 is a cross-sectional view of the substrate of FIG. 8, when applied to the fingers of the user's hand; and

FIG. 10 is a front perspective view of the substrate of FIG. 9.

### BEST MODE OF CARRYING OUT THE INVENTION

As illustrated by the appended drawings, the present article basically comprises a substrate “S” of flexible material, which is water and oil insoluble and consists of a basic film 10, whose front face incorporates, in a single piece, a plurality of projecting tabs 11 mutually interconnected in order to define, with each other and with the basic film 10, substantially prismatic cavities 12 of any polygonal base and being anteriorly open.

With the construction defined above, the substrate “S” is defined by a three-dimensional film which may be made so as to distribute the cavities 12 in different arrangements and patterns. A particular arrangement, which is illustrated, has cavities with hexagonal contour in the form a honeycomb, having sufficient stability to prevent said three-dimensional structure from collapsing during the use of the article in its functions of storing and applying the product contained therein.

The substrate “S” can be obtained from polyolefin resins, such as low-density polyethylene, medium density linear polyethylene, high-density polyethylene, polypropylene and other similar materials, preferably polyethylene. The resin composition may vary to allow controlling the thickness of the three-dimensional film, its resistance against compression and also the superficial texture of the front face, which is going to contact the user's body during the application of the product.

Due to the usual reduced thickness of the wall of the basic film 10 and of the cavities 12, which is necessary to obtain the desired superficial texture for the article in its application function, it may be necessary to increase the stiffness of the basic film 10, without modifying the stiffness of the projecting tabs 11. The increase in the stiffness of the basic film 10 may be required to provide the article with a certain minimum structural stability in its open, substantially planar and ready to use operational condition.

One possible solution for controlling the structural stiffness of the basic film 10 is to incorporate to the rear face thereof a stiffening film 20 of the same material of the substrate “S”, or other water and oil insoluble material and even impermeable to liquids and vapors in some applications, defining a thermoplastic stiffening film, for example of polyethylene, polypropylene, rayon fibers, cellulose, polyester, acrylic fibers, acetate fibers, polyester fibers and polyamide fibers, or mixtures thereof.

The present article further comprises a single amount of a dry, substantially dry, pasty-liquid or liquid product “P” for body care, including face, hair or nails, which is applied onto the front face of the basic film 10, in order to at least partially fill a certain number of cavities 12 into which it is retained.

The three-dimensional shape developed for the substrate “S”, provided anteriorly to the cavities 12, allows the latter to be completely or partially filled with a dry, substantially dry, pasty-liquid or liquid product “P”, which is more fixedly adhered to the substrate “S” due to the action of the projecting tabs 11 which define the cavities 12.

In the case of dry or substantially dry products, such as personal hygiene or skin or hair treatment products to be moistened by the user immediately before or during application onto the body, the retention thereof to the substrate “S” inside the cavities 12 is obtained by different deposition and dehumidifying processes which assure the mechanical bonding of the product to the substrate, such bonding being facilitated by the cavities 12.

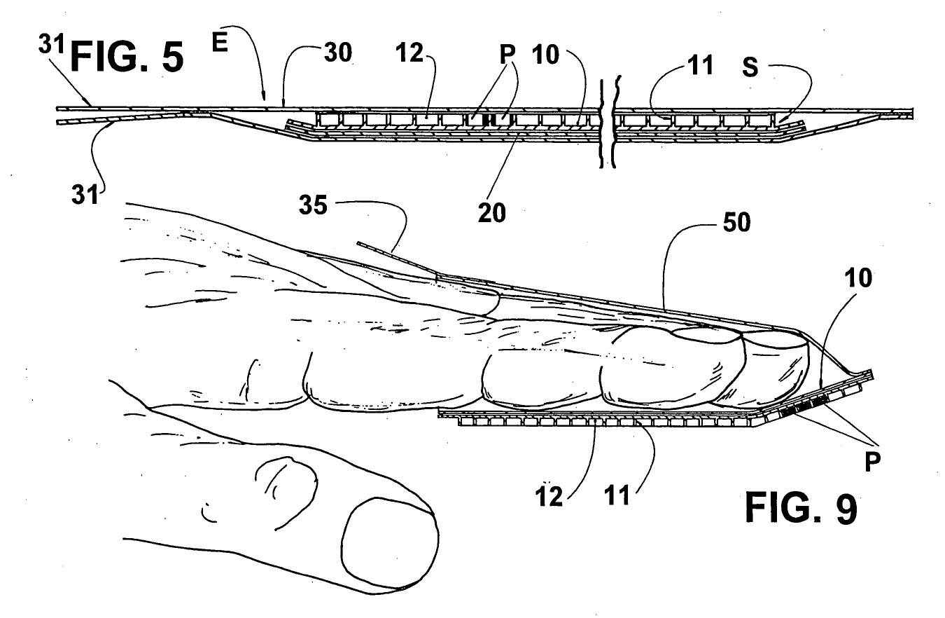

In the case of dry or substantially dry products “P”, their stability in the substrate “S” is mechanically assured by the bonding to the basic film 10 and projecting tabs 11, no additional means being required to provide a secure retention of the product “P” to the substrate “S”, before and during its use, as illustrated in FIG. 5.

In such cases, one or more substrates may be packaged flattened inside an envelope “E” made of one or two portions of films 30 of suitable material, preferably impermeable to aqueous and oily liquids and vapors, such as polyethilene, polypropilene, polyesther, cellulose, rayon fibers, multiple foils impregnated with aluminum, or mixtures thereof, with the free edges thereof being mutually welded in order to be manually separated by the user upon opening the package.

In order to facilitate the separation of the two films 30 which constitute the envelope “E” they can incorporate, in one of the edges and usually in a single piece, an outwardly projecting tab 31 for manual gripping. Tabs 31 allow envelope “E” to be easily opened by the user, with no auxiliary tool being required for a ready and easy access to the substrate.

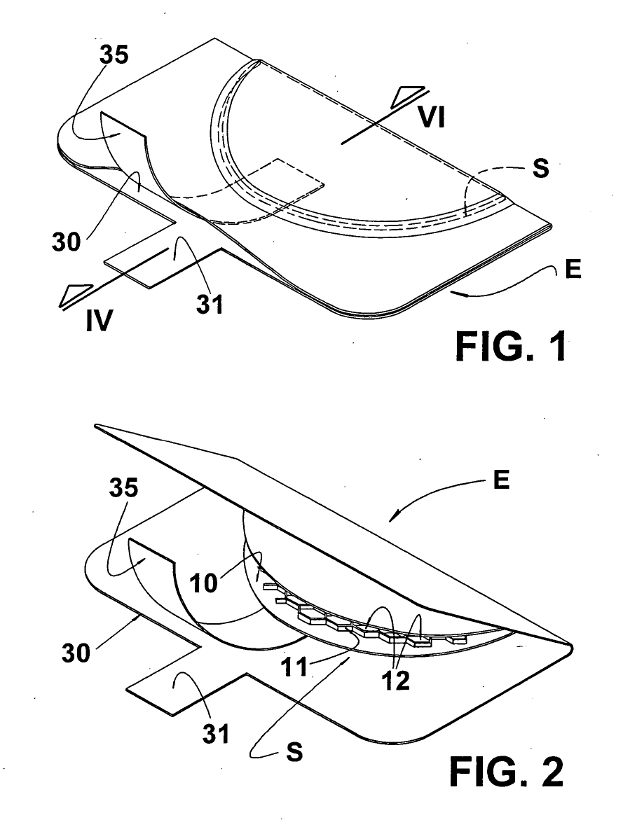

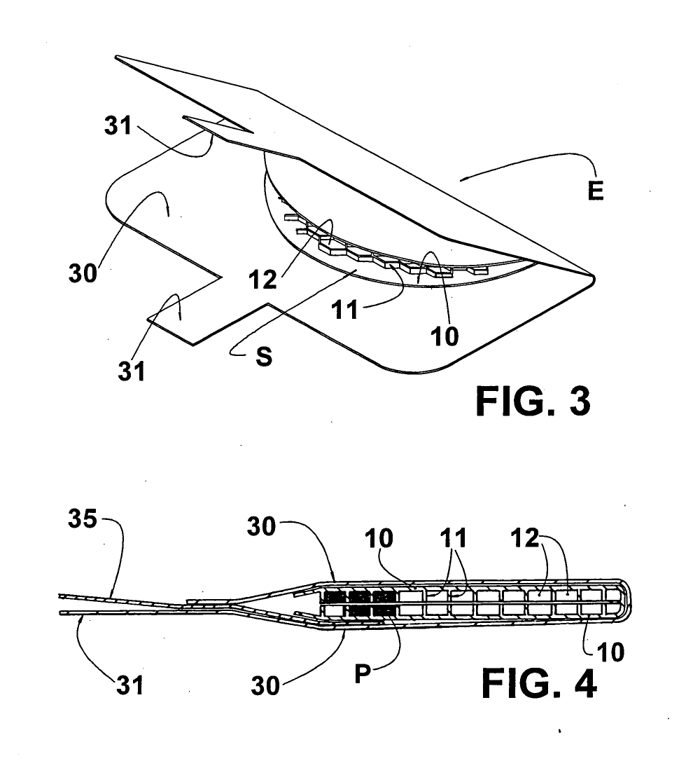

It should be understood that the substrate “S”, which is flattened and contains an amount of dry or substantially dry product “P” may be then packaged in an envelope “E”, such as illustrated in FIGS. 1, 2, 3 and 4, defined by a single film 30 which is folded in order to surround the front and rear portions of the substrate “S” and having its overlapping edges welded or otherwise hermetically affixed to each other, to be separated upon the opening of envelope “E” by the user. The hermetic welding of the edges of the film 30 can be carried out by any suitable process to allow the posterior opening such as, for example, by crimping, sealing or gluing.

When the product “P” to be contained in substrate “S” is pasty-liquid, as it occurs with creams, lotions and shampoos, the cavities 12 are usually sufficient to retain the product therein only when they are facing upward. In this case, the retention of such products is obtained by folding the substrate “S” in half, as illustrated in FIGS. 1, 2, 3 and 4, so that the openings of the cavities 12 of one of the halves of the substrate “S” are seated against the openings of the cavities 12 of the other half of substrate “S”, promoting the retention of the product inside the folded substrate “S”.

As illustrated in FIGS. 1 and 2, one of the tabs 31 of manual gripping for opening the envelope “E” may be replaced by a strip 35 projecting outwardly from envelope “E” and overlapping a tab 31 and having an opposite end portion affixed to the back of substrate “S”, not only allowing the opening of envelope “E”, when operated together with the remaining tab 31, but also the easy and comfortable gripping of the substrate “S” at a projecting portion distant from the cavities 12 area and therefore from the product “P” to be applied to the user.

The dimensioning of the wall thickness, height and contour of the cavities 12 is done in function of the type of product “P” to be stored and applied to the user since, besides operating so as to be able to contain products “P” which leak when subjected to gravity, the cavities 12 have their surrounding projecting tabs 11 designed to perform functions related to the correct application of the product “P” to the user's body, and they should be softer in some cases and stiffer in other cases where a certain exfoliating or foam production effect is desired. For example, if the projecting tabs 11 are excessively fragile and soft, they will not have sufficient structure to retain the product “P” of the pasty-liquid type when compressed upon folding the substrate “S”.

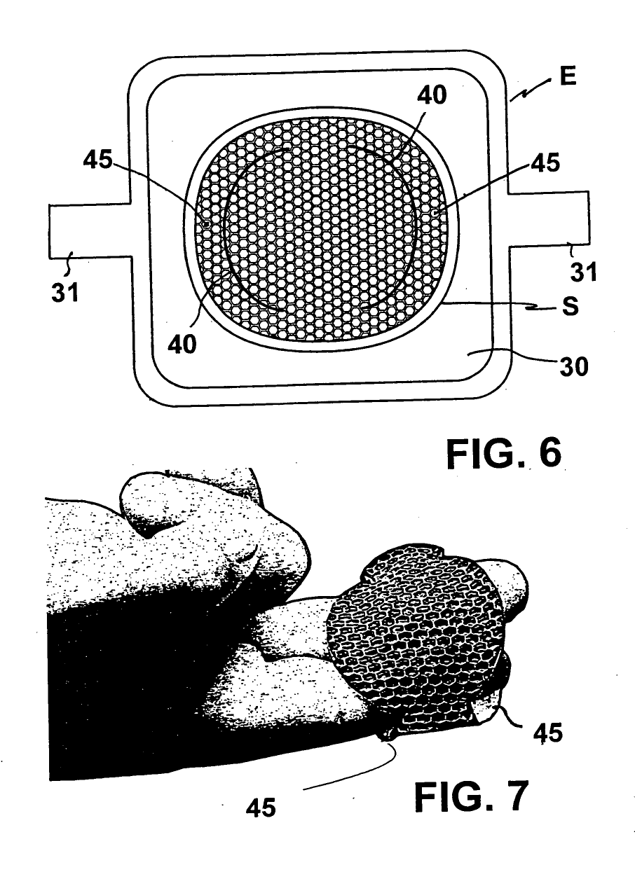

FIG. 6 illustrates a front plan view of a substrate “S” of substantially circular contour and already flattened after the complete opening of envelope “E” of single film 30, in which inside it was packaged folded in half.

In this embodiment, the substrate “S” is provided with two arcuate cuts 40, which are diametrally opposite and concentric in relation to each other and to the contour of the substrate “S”, in order to define, with the adjacent edge of the latter, a gripping means in the form of a pair of handles 45 that can be folded backwards, in order to allow the surrounding of two or more fingers of the user's hand and the consequent manual retention of the article in an operative condition, such as illustrated in FIG. 7.

It should be understood that different types of gripping means may be formed, with the shape of, for example, handles affixed to the user's hand and which may be defined or not by a portion of the substrate “S” itself. The handle may be defined, for example, by a strip (not shown) of suitable material and having its end portions fixed at the rear portion of substrate “S”.

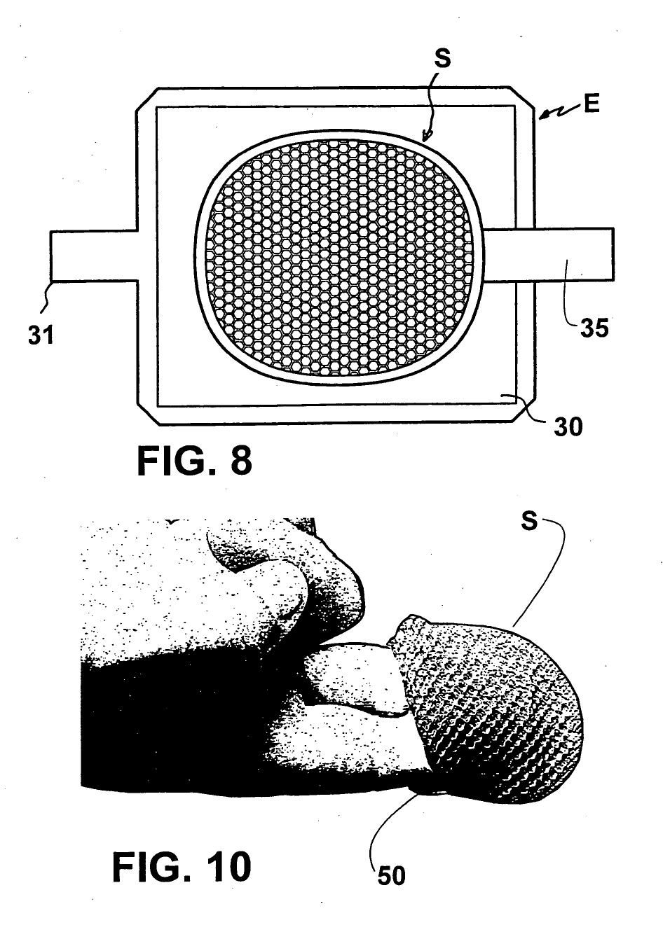

An alternative embodiment for the handle is illustrated in FIGS. 8, 9 and 10. In this case, the handle takes the form of a posterior cover 50 peripherally affixed to the peripheral edge of the substrate “S”, in order to define therewith a kind of small glove, inside which the user's fingers are fitted.

It should be also understood that the substrate “S” may be provided with a posterior gripping means in the form of an adhesive film (not shown), which is designed to assure the adequate gripping of the article provided or not with handles or a posterior cover to be coupled to the fingers of the user's hand. Due to the great versatility achieved with the substrate “S” of the present invention, which may be stored flattened or folded in half, it is possible for its cavities 12 to suitably store and retain a wide range of products for body, face, hair or nails care, either individually or jointly and including, for example, anti-acne, anti-wrinkle, anti-inflammatory, anti-microbial agents, anesthetics, sunscreening lotions, or anti-oxidant products and mixtures thereof, soaps, cleansing lotions, moisturizers, shampoos and conditioners in the dry, substantially dry, pasty-liquid or liquid state.

1. Portable disposable personal article containing a product for body care, including face, hair and nails, characterized in that it comprises a substrate (S) of flexible material, which is water and oil insoluble and consists of a basic film (10) having a front face incorporating, in a single piece, a plurality of projecting tabs (11), which are mutually interconnected, in order to define, with each other and with the basic film, substantially prismatic cavities (12) of any polygonal base and anteriorly opened, and a single amount of a product (P) in one of the dry, substantially dry, pasty-liquid, or liquid forms for body care, including face, hair or nails, deposited on the front face of the basic film (10), in order to fill at least partially a certain number of cavities, in which it is retained.

2. Article, according to claim 1, characterized in that the substrate (S) is obtained from polyolefin resins.

3. Article, according to claim 2, characterized in that the substrate (S) is obtained from one or more of the materials selected from the group consisting of low density polyethylene, medium density linear polyethylene, high density polyethylene, polypropylene and mixtures thereof.

4. Article, according to claim 2, characterized in that the substrate (S) is preferably obtained from polyethylene.

5. Article, according to claim 1, characterized in that the basic film (10) is later incorporated to a stiffening film (20) of water and oil insoluble material and with a thickness which is dimensioned to induce the basic film (10) to take a substantially flat operative condition.

6. Article, according to claim 5, characterized in that the stiffening film (20) is obtained from one or more of the materials selected from the group consisting of polyethylene, polypropylene, rayon fibers, cellulose, polyester, acrylic fibers, acetate fibers, polyester fibers, polyamide fibers and mixtures thereof.

7. Article, according to claim 1, characterized in that the cavities (12) have hexagonal periphery in the form of a honeycomb.

8. Article, according to any of the claims 1-7, characterized in that the substrate (S) carries, in its rear portion, a gripping means (45, 50) for retention to the fingers of the user's hand

9. Article, according to claim 8, characterized in that the gripping means is defined by a pair of handles (45) consisting of opposite edge portions of the substrate (S2), foldable backwards along respective cuts (40) defined on the substrate (S).

10. Article, according to claim 8, characterized in that the gripping means is defined by at least one handle (50) having end portions affixed to the rear and edge portions of the substrate (S).

11. Article, according to claim 10, characterized in that the handle takes the form of a back cover (50) peripherally affixed to the peripheral edge of the substrate (S), in order to form therewith a small glove for fitting the user's fingers.

12. Article, according to claim 8, characterized in that the gripping means comprises an adhesive film.

13. Article, according to any of the claims 1-12, characterized in that it further comprises an envelope shaped package (E) formed by two film portions (30) and having the free edges hermetically and releasably welded to each other, said envelope enclosing at least one substrate (S) therein.

14. Article, according to claim 13 and wherein the product (P) is a dry or substantially dry product, characterized in that the two film portions (30) are obtained from a material that is permeable to aqueous and oily liquids and vapors

15. Article, according to claim 13 and wherein the product (P) is pasty-liquid or liquid, characterized in that the two film portions (30) are obtained from a material that is impearmeable to aqueous and oily liquids and vapors.

16. Article, according to claim 13, characterized in that the substrate (S) is placed in a flat manner inside the envelope (E).

17. Article, according to claim 13, characterized in that the substrate (S) is placed inside the envelope (E) in a folded in half condition, so that the openings of the cavities (12) of one of the halves of the substrate (S) are seated against the openings of the cavities (12) of the other of said halves.

18. Article, according to claim 13, characterized in that at least one of the film portions (30) which form the envelope (E) incorporates a tab (31), for manual gripping, projecting outwardly from the edge of said film portion (30).

19. Article, according to claim 18, characterized in that a strip (35) is provided, having an end portion affixed to the rear of substrate (S) and an opposite end portion projecting outwardly from envelope (E) adjacent to a tab (31) for manual gripping thereof.

20. Article, according to claim 13, characterized in that the two film portions (30) define a single piece, which is folded around the substrate (S).
